(19) United States
(12) Patent Application Publication
(10) Pub. No.: US 2002/0020746 A1
(43) Pub. Date: Feb. 21, 2002

(54) System and method for optical coding

(75) Inventor: Alexander R. Roustaei, La Jolla, CA (US)

Correspondence Address: Mitchell P. Brook, Esq., BAKER & McKENZIE, 101 West Broadway, 12th Floor, San Diego, CA, 92101-3890, US

(73) Assignee: SEMICONDUCTOR INSIGHTS, INC.

(21) Appl. No.: 09/947,855

(22) Filed: Sep. 6, 2001

Related U.S. Application Data
(63) Continuation-in-part of application No. 09/208,284, filed on Dec. 8, 1998.
Application No. 09/208,284 is a continuation-in-part of application No. 09/073,501, filed on May 5, 1998, now Pat. No. 6,123,261.
(60) Provisional application No. 60/067,913, filed on Dec. 8, 1997.
(60) Provisional application No. 60/070,043, filed on Dec. 30, 1997.
(60) Provisional application No. 60/072,418, filed on Jan. 24, 1998.

(51) Int. Cl. G06K 7/10

(52) U.S. Cl. 235/462.01

(57) ABSTRACT

A system and a method for optical coding are provided in which an identifier includes information about optically coded information that is stored in one or more dimensions in a logo and/or design. The identifier and the optically coded information are structured to blend in with or hide within the logo and/or design.

This is a continuation-in-part of U.S. patent application Ser. No. 09/208,284, filed on Dec. 8, 1998, which is a continuation-in-part of U.S. patent application Ser. No. 09/073,501, filed May 5, 1998, issued as U.S. Pat. No. 6,123,261 on Sep. 26, 2000.

### FIELD OF THE INVENTION

The present invention generally relates to a system and a method for optical coding.

### BACKGROUND OF THE INVENTION

Conventional bar code symbologies of the one-dimensional variety have found a number of applications. Information may be optically stored within black and white rectangular bars that are aligned in a single row. The information may then be read and decoded by a conventional bar code reading system. However, such conventional symbologies have proven to be inflexible. Furthermore, such conventional symbologies tend to stand out when printed on, for example, products, packaging and/or labels. Often such conventional symbologies visually distract or detract from or overpower design features found on the product, packaging, logos and/or other design features.

### SUMMARY OF THE INVENTION

The present invention alleviates to a great extent the disadvantages of the known apparatus and methods for optical coding. In a preferred embodiment, the present invention provides a data field including pixels encoded with data and an identifier including pixels encoded with information used in reading and decoding the data encoded in the data field.

The present invention provides that a system and a method for optical coding use a flexible approach. The data field and the identifier are blended in or hidden in a design such as, for example, a logo or product design by appropriately selecting, for example, the shape, configuration and/or encoding scheme of the data field and the identifier.

The identifier includes pixels that are optically encoded with information relating to the identifier and the data field. The pixels of the identifier include pixels encoded with a data string that indicates a predetermined value in a predetermined configuration that allows an optical reading system to locate the identifier. The pixels of the identifier also then provide information relating to the location and size of the data field with respect to the identifier. The identifier also has encoded information relating to the direction and orientation of the data in the data field as well as the applicable encoding scheme and error correction technique. In short, the identifier contains information that the optical reading system may employ in reading and decoding information contained in the identifier and the data field.

The pixels of the identifier and the data field may be selected from a wide variety of shapes and configurations. Furthermore, the pixels may be encoded by black, white, gray or color or shading codes in one or more dimensions. With such flexibility in selecting the parameters and the encoding schemes of the pixels, the data field and the identifier can be hidden or made to blend in with a product design or label.

These and other features and advantages of the present invention will be appreciated from review of the following detailed description of the present invention, along with the accompanying figures in which like reference numerals refer to like parts throughout.

### BRIEF DESCRIPTION OF THE DRAWINGS

FIG. 1 shows a schematic representation of an embodiment in which information is encoded in a logo according to the present invention;

FIG. 2 shows a schematic representation of another embodiment in which information is encoded in a logo and design according to the present invention;

FIG. 3 shows an embodiment of an identifier according to the present invention;

FIG. 4 shows another embodiment of the identifier according to the present invention;

FIG. 5 shows a schematic representation of exemplary types of information that may be stored in the identifier according to the present invention;

FIG. 6 shows another embodiment of the identifier according to the present invention;

FIG. 7 shows an embodiment of optically coded information according to the present invention;

FIG. 8 shows an embodiment of the identifier with half-filled pixels according to the present invention; and

FIG. 9 shows an embodiment of an optically coded information delimited by incomplete pixels according to the present invention.

### DETAILED DESCRIPTION OF THE INVENTION

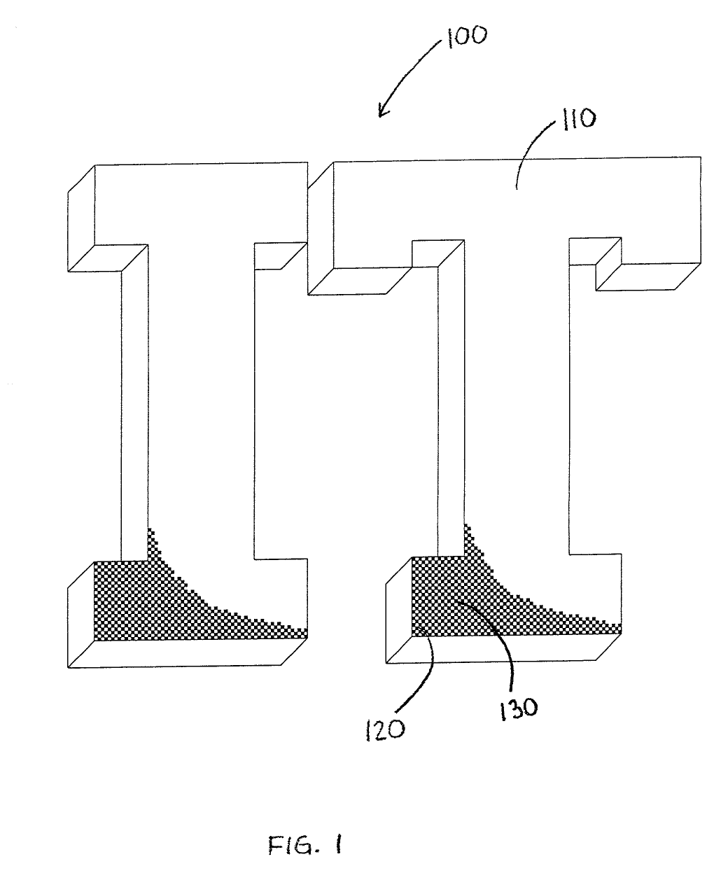

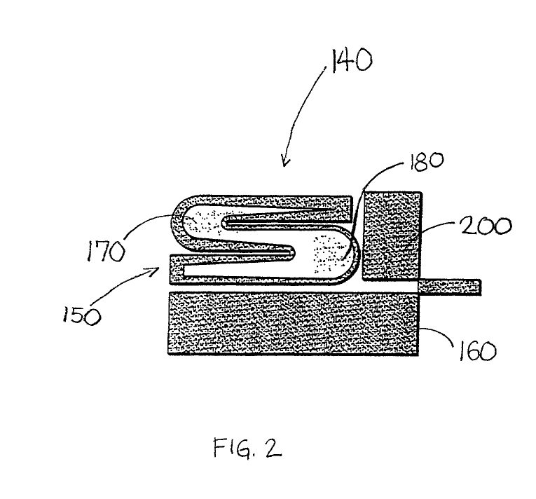

FIGS. 1 and 2 show exemplary embodiments of logos and/or designs in which is hidden optically coded information according to the present invention. FIG. 1 illustrates an exemplary logo 100 including, for example, stylized lettering 110 (e.g., “IT”) with shaded areas 120. In at least a portion of one of, for example, the shaded areas 120, information is stored in optical coding 130 (e.g., two-dimensional symbology). FIG. 2 illustrates another exemplary logo 140 including stylized lettering 150 (e.g., “S”) and design features 160. The logo 140 also includes shaded areas 170. In at least a portion of one of, for example, the shaded areas 170, information is stored in optical coding 180. In either exemplary logo 100, 140, the optical coding 130, 180 has been selected to blend in with the logo 100, 140.

The present invention also contemplates that the optically coded information can be hidden elsewhere in the logo and/or design. For example, in FIG. 2, the optically coded information 180 could have been hidden in another portion of the lettering 150 or the design features 160 such as, for example, portion 200. Furthermore, the present invention contemplates blending the optically coded information into, for example, product designs and/or labels.

In order for an optical reading system (not shown) to read and to decode the optically coded information, the optical reading system should initially locate the optically coded information which may be hidden in a logo and/or design and then ascertain information useful in decoding the optically coded information.

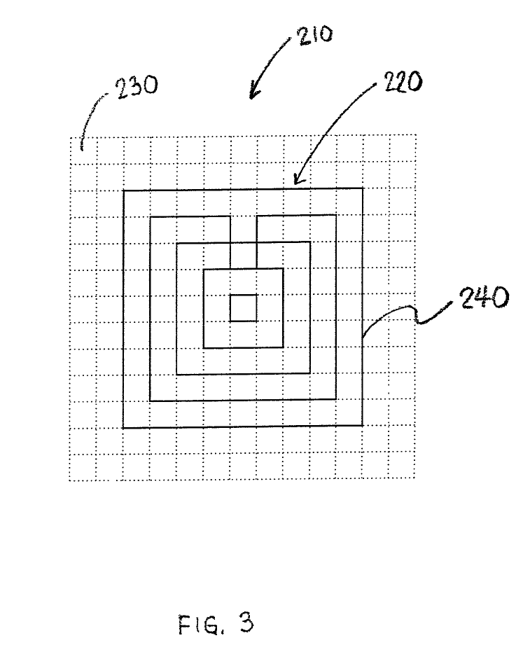

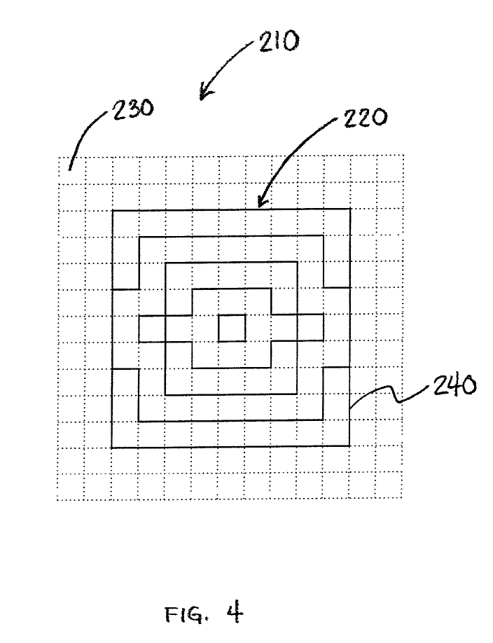

FIGS. 3 and 4 show exemplary embodiments of identifiers 220 according to the present invention. FIGS. 3 and 4 show a portion 210 of optically coded information and the identifier 220. Although FIGS. 3 and 4 illustrate the identifier 220 within the optically coded information, the present invention also contemplates that the identifier 220 may also be outside the optically coded information or partially outside the optically coded information. The identifier 220 includes parameters and/or information relating to the identifier 220 and the optically coded information. The identifier 220 may include, for example, parameters relating to the optically coded information including, for example, symbology type, codification structure, contrast, color, direction, orientation, error correction and/or locations within the identifier and the optically coded information.

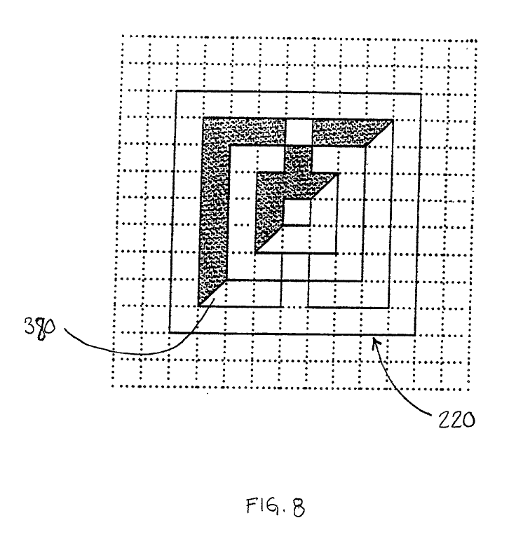

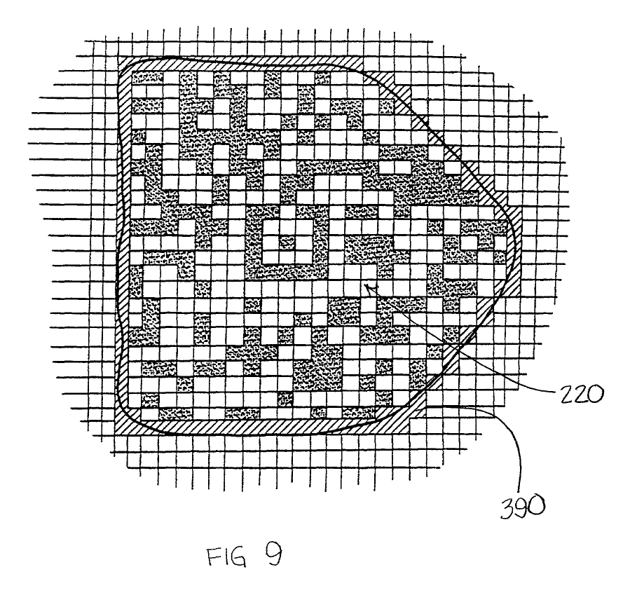

The portion 210 of the optically coded information includes pixels 230 (e.g., square pixels) that each contains information which has been optically coded. For example, pixel 230 may be black or white to encode binary numbers. Alternatively, grayscale coding may be employed in which varying shades of gray between black and white are used for each pixel 230 to provide alternative methods of encoding when used in combination or in the alternative with the above-described encoding schemes. Furthermore, the pixels 230 may be shaded in part as shown in pixel 380 illustrated in FIG. 8, or the pixels 230 may be incomplete or partially shaded to set the periphery of the identifier 220 or the optically coded information as illustrated by pixels 390 in FIG. 9. Each pixel 230 may include a plurality of pixels or pixel elements. Thus, colors may provide additional density to the coding via the plurality of pixels or other optical coding elements in each pixel 230. Accordingly, for example, information may be coded using the primary colors of red, yellow and blue; by separating out the colors, at least three times the information may be optically encoded per pixel 230. The present invention also contemplates using other groups of colors.

The identifier 220 includes a set of pixels 230 that store information with which the optical reading system may locate and decode optically coded information. Darkened lines 240 as illustrated, for example, in FIGS. 3 and 4 may or may not be present in the identifier 220. In one embodiment of the present invention, the optical reading system may use the darkened lines as a target or reference to locate the identifier. By appropriately encoding the pixels 230 of the identifier 220, the identifier 220 can be adapted to blend in with the surrounding optically coded information. Thus, the identifier 220 and the optically coded information can be adapted to blend in or to be hidden in, for example, a logo and/or design.

Although the pixels 230 and/or the identifier 220 are illustrated as square, the present invention may provide other shapes and configurations (e.g., circular, polygonal, polar, etc. Thus, the pixels 230 and/or the identifier 220 may be one-, two- and/or three-dimensional. For example, the pixels 230 may be formed and/or configured in a myriad of shapes (e.g., circles, polygons, bars, poles, etc.) Indeed, the choice of the shape of the pixels 230 or the identifier 220 may be made in consideration of which shape or configuration best hides and/or blends the optically coded information with, for example, the logo and/or design.

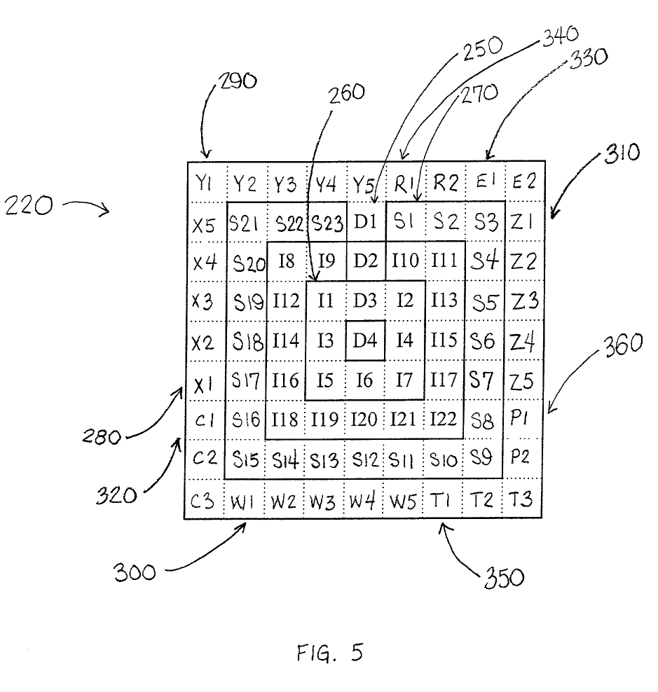

FIG. 5 shows an exemplary identifier 220 according to the present invention in which the pixels 230 of the identifier 220 are labeled to indicate specific information that has been optically coded in the identifier 220 for possible use by the optical reading system in reading all of the optically coded information. However, the present invention also contemplates other identifiers 220 having other shapes, configurations and/or data string types.

In an exemplary embodiment, the present invention provides that, before the optical reading system can decode information represented in the identifier 220, the optical reading system locates the identifier 220 via a single data string 270 and/or, if present, the darkened lines 240. The single data string 270 includes pixels S1-S23 that represent a predetermined value for which the optical reading system would search. Accordingly, in searching for the single data string 270, enough information (e.g., the predetermined value and/or the configuration of the single data string 270) should already be known to the optical reading system for the optical reading system to locate the single data string 270. In an exemplary example, the single data string 270 may only include white pixels S1-S3 representing a string of binary zeroes which appear as a white collar in the identifier 220. Alternatively, the present invention also contemplates other predetermined values for the single data string 270 and/or other configurations for the single data string 270.

Pixels D1-D4 form a direction data string 250. The direction data string 250 represents information relating to the direction of the optical data relative to the identifier 250. The data may be encoded as, for example, black or white. For example, the binary number 1010 may be encoded in the direction data string 250 by making pixels D2 and D4 black and pixels D1 and D3 white. By decoding the direction data string 250, the optical reading system may ascertain, for example, in which direction the optically coded information is stored relative to the identifier 220.

Pixels I1-I22 form an orientation data string 260 that represents information relating to the orientation of the optically encoded data relative to the identifier 220. For example, the orientation data string 260 may indicate that the optically coded information may be stored in rows that should be read from top to bottom and from left to right. Alternatively, the orientation data string 260 may indicate, for example, that the optically coded information may be stored in a spiral configuration that should be read in a clockwise or counter-clockwise manner.

Pixels X1-X5 and pixel Y1-Y5 form a rows data string 280 and a columns data string 290, respectively. The rows data string 280 and the columns data string 290 indicate the number of rows and columns, respectively, of the optically coded information. Thus, in an exemplary embodiment in which the row data string 280 and the columns data string 290 each have five pixels that are binary coded, then the optically coded information might contain up to thirty-two rows and up to thirty-two columns. By increasing, for example, the density of the coding and/or the number of pixels dedicated to the rows data string 280 and/or the columns data string 290, the quantity of information that is optically coded may be increased. Increases in the number of pixels dedicated to the rows data string 280 and/or the columns data string 290 may be accommodated by changing, for example, the shape and/or the size of the identifier 220.

Pixels W1-W5 and pixels Z1-Z5 form an identifier row data string 300 and an identifier column data string 310. The identifier row data string 300 and the identifier column data string 310 indicate, for example, an address or a location of a predetermined pixel. The predetermined pixel provides location information relating to the identifier 220. For example, the predetermined pixel could relate to a pixel within the identifier 220 such as the top left comer pixel or, alternatively, the center pixel of the identifier 220.

Pixels C1-C3 form an encoding data string 320. The encoding data string 320 indicates the encoding scheme. Thus, the value of the encoding data string 320 may indicate that information was optically encoded using methods such, for example, as Code 49, PDF-417, MaxiCode or VeriCode. For example, if the encoding data string 320 were binary encoded with 001 (i.e., C3=0, C2=0 and C1=1), then the encoding data string 320 might be indicating that the MaxiCode encoding scheme was employed.

Pixels E1-E2 form an error correction data string 330 that indicates the implemented method of error correction. The optical reading system can then use the implemented error correction scheme to insure that the information read from the optically encoded information is accurate. Error techniques are advantageous in use with optical reading systems because optical reading errors are not uncommon. Conventional error correction schemes include, for example, Reed-Solomon and Convolution techniques. Accordingly, if the error correction data string 330 were binary encoded as 00 (i.e., E2=0 and E1=0), then the optical reading system would know to implement, for example, the Reed-Solomon error correction technique.

Other pixels may incorporate other types of information. For example, pixels R1-R2 may form a ratio data string 340 that indicates the density and ratio of the optically coded information. Pixels T1-T3 may form a topology data string 350 that indicates the shape and/or the topology of the optically coded information (e.g., circular, rectangular, polygonal, etc.) Pixels P1-P2 may form a color data string 360 that indicates any color and/or contrast information that was employed in optically coding the information. For example, if the color data string 360 were binary coded as, for example, 00 (i.e., P2=0 and P1=0), then the optically coded information may be coded in black and white. Alternatively, if the color data string 360 were binary coded as, for example, 01 (i.e., P2=0 and P1=1), then information may be coded in, for example, using the primary colors.

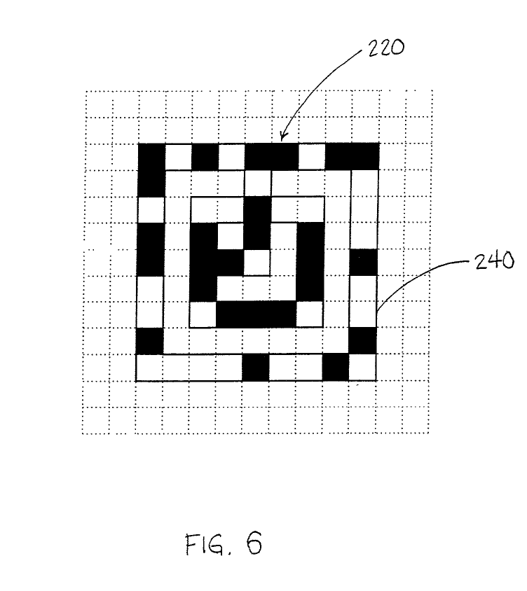

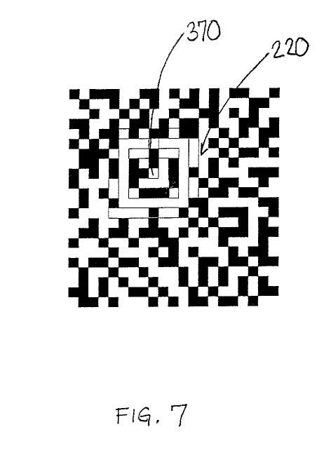

As an example, FIGS. 6 and 7 show the identifier 220 that is located within the optically coded information according to the present invention. According to the identifier 220, the following values have been programmed for the following strings, wherein black is a binary 1 and white is a binary 0:

| | |
|---|---|
| Single Data String (S23-S1) | 000 0000 0000 0000 0000 0000 |
| Direction Data String (D4-D1) | 0110 |
| Orientation Data String (I22-I1) | 01 1101 1111 1000 0000 0101 |
| Rows Data String (X5-X1) | 10110 |
| Columns Data String (Y5-Y1) | 10101 |
| Identifier Row Data String (W5-W1) | 01000 |
| Identifier Column Data String (Z5-Z1) | 01000 |
| Encoding Data String (C3-C1) | 010 |
| Error Correction Data String (E2-E1) | 11 |
| Ratio Data String (R2-R1) | 01 |
| Topology Data String (T3-T1) | 010 |
| Color Data String (P2-P1) | 10 |

In light of the above binary coded strings, a few further exemplary observations according to the present invention are discussed herein. For example, the identifier 220 employs the single data string 270 that has a binary code with a value of zero (i.e., the single data string 270 is a string of twenty-three binary zeroes). The optical reading system can locate the single data string 270 by, for example, its predetermined value, its predetermined configuration and/or, if present, the darkened lines 240 of the identifier 220. Having located the single data string 270, the optical reading system has found the identifier 220 and can extract the information encoded therein. For example, the row data string 280 and the columns data string 290 have binary codes indicating values of twenty two and twenty one, respectively. Accordingly, the identifier 220 indicates that the optically encoded information is characterized by twenty-two rows and twenty-one columns as shown in FIG. 6. The identifier row data string 300 and the identifier column data string 310 have binary codes both indicating a value of eight. Accordingly, the predetermined pixel is located in the eighth row and the eighth column of the optically coded information which the imaging system knows is, for example, the center pixel 370 of the identifier 220. Thus, using these and the other strings in the identifier 220, the optical reading system can locate the identifier 220, decode the information stored in the pixels 230 of the identifier 220 and, subsequently, accurately decode the information stored in the pixels 230 of the optically coded information contained in the twenty-two rows and twenty-one columns.

Thus, it is seen that an apparatus and method for optical coding have been provided. One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description may practice the present invention as well.

What is claimed is:

1. A system for optically coding information in a design, comprising:
a data field including pixels that are optically coded with data; and
an identifier including pixels that are optically coded with information about the identifier and the data field,
wherein the pixels of the data field and the pixels of the identifier are coded and configured to blend in with the design.

2. The system according to claim 1, wherein the identifier includes darkened lines that are used in locating the identifier.

3. The system according to claim 1, wherein the pixels of the identifier include pixels that are encoded with a data string having a predetermined value that is used in locating the identifier.

4. The system according to claim 1, wherein the pixels of the identifier include pixels that are encoded with a data string having a predetermined value and a predetermined configuration that are used in locating the identifier.

5. The system according to claim 1, wherein the pixels of the identifier include pixels that are encoded with a data string that indicates a direction of the data with respect to the identifier.

6. The system according to claim 1, wherein the pixels of the identifier include pixels that are encoded with a data string that indicates an orientation of the data with respect to the identifier.

7. The system according to claim 1, wherein the pixels of the identifier include pixels that are encoded with a data string that indicates a size of the data field.

8. The system according to claim 1, wherein the pixels of the identifier include pixels that are encoded with a first data string and a second data string that indicate a number of rows and a number of columns of data in the data field.

9. The system according to claim 1, wherein the pixels of the identifier include pixels that are encoded with a data string that indicates a predetermnined location within the identifier.

10. The system according to claim 1, wherein the pixels of the identifier include pixels that are encoded with a first data string and a second data string that indicate a row and a column of a predetermined location within the identifier.

11. The system according to claim 1, wherein the pixels of the identifier include pixels that are encoded with a first data string and a second data string that indicate a row and a column of a center location of the identifier or a comer location of the identifier.

12. The system according to claim 1, wherein the pixels of the identifier include pixels that are encoded with a data string that indicates an encoding scheme used in the optically coded data.

13. The system according to claim 12, wherein the encoding scheme is selected from any one of the group consisting of: Code 49, PDF-417, Maxi-Code, VeriCode, Code 16K, DataMatrix, Code One, and Super Code.

14. The system according to claim 1, wherein the pixels of the identifier include pixels that are encoded with a data string that indicates an error correction scheme used in the optically coded data.

15. The system according to claim 14, wherein the error correction scheme is selected from any one of the group consisting of: Reed-Solomon technique, Convolution technique, and any other suitable technique.

16. The system according to claim 1, wherein the pixels of the identifier include pixels that are encoded with a data string that indicates at least one of a density and a ratio used in the optically coded data.

17. The system according to claim 1, wherein the pixels of the identifier include pixels that are encoded with a data string that indicates at least one of a shape and a topology used in the optically coded data.

18. The system according to claim 1, wherein the pixels of the identifier include pixels that are encoded with a data string that indicates at least one of color information and contrast information used in the optically coded data.

19. The system according to claim 18, wherein color information indicates that the data is encoded by selectively using three primary colors and other color combinations.

20. The system according to claim 1, wherein the pixels of the identifier or the data field include pixels that are half-filled or incomplete.

21. The system according to claim 20, wherein the half-filled or incomplete pixels delimit a periphery of the data field or the identifier.

22. The system according to claim 1, wherein the pixels of the identifier or the data field include one-, two- or three-dimensional pixels.

23. The system according to claim 1, wherein the pixels of the identifier or the data field include circular pixels.

24. The system according to claim 1, wherein the pixels of the identifier or the data field include polygonal pixels.

25. The system according to claim 1, wherein the pixels of the identifier or the data field include pixels having a shape selected from any one of the group consisting of. a circle, a polygon, a bar, a pole, a square, and a rectangle.

26. The system according to claim 1, wherein the pixels of the identifier or the data field include pixels encoded with a gray-scale encoding scheme.

27. The system according to claim 1, wherein the design is a logo.

28. The system according to claim 1, wherein each pixel of the data field or each pixel of the identifier includes a plurality of pixels or pixel elements.

29. A method for optical coding, comprising the steps of:
blending in pixels of an identifier and pixels of a data field in a design;
locating an identifier by identifying pixels of the identifier that are encoded with a data string having a predetermined value and that have a predetermined configuration; and
determining parameters relating to a data field from information optically encoded in the pixels of the identifier.

30. The method according to claim 29, further comprising the step of:
reading and decoding information optically encoded in the pixels of the data field using information optically encoded in the identifier.

31. The method according to claim 29, wherein the step of locating an identifier includes the step of finding darkened lines of the identifier.

32. The method according to claim 29, wherein the step of blending includes the step of blending in pixels of an identifier and pixels of a data field in a logo.

33. The method according to claim 29, further comprising the step of:
optically encoding in the pixels of the identifier information relating to a direction of the data field with respect to the identifier.

34. The method according to claim 29, further comprising the step of:
optically encoding in the pixels of the identifier information relating to a size of the data field.

35. The method according to claim 29, further comprising the step of:
optically encoding in the pixels of the identifier information relating to a predetermined location of the identifier.

36. The method according to claim 29, further comprising the step of:.
optically encoding in the pixels of the identifier information relating to an encoding scheme used in the data field.

37. The method according to claim 29, further comprising the step of:
optically encoding in the pixels of the identifier information relating to an error correction scheme used in the data field.

38. The method according to claim 29, further comprising the step of:
optically encoding in the pixels of the identifier information relating to at least one of a density and a ratio used in the data field.

39. The method according to claim 29, further comprising the step of:
optically encoding in the pixels of the identifier information relating to at least one of color information and contrast information used in the data field.

40. The method according to claim 29, further comprising the step of:
optically encoding in the pixels of the identifier information relating to an orientation of optically encoded information of the data field.

41. The method according to claim 29, further comprising the step of:
optically encoding in the pixels of the identifier information relating to at least one of a topology and a shape of optically encoded data of the data field.
